(19) United States
(12) Patent Application Publication
(10) Pub. No.: US 2026/0180090 A1
(43) Pub. Date: Jun. 25, 2026

(54) ELECTRICAL ENERGY STORAGE DEVICE

(71) Applicant: Prime Planet Energy & Solutions, Inc., Tokyo (JP)

(72) Inventor: Yozo UCHIDA, Toyota-shi (JP)

(21) Appl. No.: 19/420,736

(22) Filed: Dec. 16, 2025

(30) Foreign Application Priority Data
Dec. 23, 2024 (JP) 2024-226053

(51) Int. Cl. H01M 50/169; H01M 50/103; H01M 50/119; H01M 50/159; H01M 50/184

(52) U.S. Cl. CPC H01M 50/169; H01M 50/103; H01M 50/119; H01M 50/159; H01M 50/184

(57) ABSTRACT

The present disclosure provides an electrical energy storage device including an electrode body, a case main body that includes an opening, a sealing plate that seals the opening, a welding joining part, and a shielding part that shields a gap between the welding joining part and the electrode body inside the case main body, in which in a peripheral edge of the welding joining part, a space that is surrounded by the shielding part, the case main body, and the sealing plate is secured.

### CROSS REFERENCE TO RELATED APPLICATION

This application claims the benefit of priority to Japanese Patent Application No. 2024-226053 filed on Dec. 23, 2024. The entire contents of this application are hereby incorporated herein by reference.

### BACKGROUND OF THE DISCLOSURE

### 1. Field

The present disclosure relates to an electrical energy storage device.

### 2. Background

Conventionally, an electrical energy storage device including an electrode body, a case main body that includes an opening and accommodates the electrode body, a sealing plate that seals the opening, and a welding joining part that is provided at a peripheral edge of the opening has been known (for example, Japanese Patent Application Publication No. 2009-026707).

### SUMMARY

When the welding joining part is formed, a molten metal may become microparticles (that is to say, weld spatter), enter the case main body from a gap between the case main body and the sealing plate, and damage the electrode body.

The present disclosure has been made in view of the above circumstances, and an object is to provide an electrical energy storage device in which damage of an electrode body due to weld spatter is suppressed.

The present disclosure provides an electrical energy storage device including: an electrode body; a case main body that includes an opening and accommodates the electrode body; a sealing plate that seals the opening; a welding joining part that is provided at a butting part between the case main body and the sealing plate; and a shielding part that shields a gap between at least a part of the welding joining part and the electrode body inside the case main body, in which in at least a part of a peripheral edge of the welding joining part, a space that is surrounded by the shielding part, the case main body, and the sealing plate is secured.

With the aforementioned structure, even if weld spatter scatters inside the case main body in welding joining, the weld spatter can be received by the space and kept away from the electrode body. Therefore, the damage of the electrode body due to the weld spatter can be suppressed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating an electrical energy storage device according to an embodiment;

FIG. 2 is a schematic longitudinal cross-sectional view taken along line II-II in FIG. 1;

FIG. 3 is an enlarged cross-sectional view of a main part in FIG. 2;

FIG. 4 is a schematic plan view of a sealing plate in FIG. 1;

FIG. 5 is a view corresponding to FIG. 3 according to a first modification;

FIG. 6 is a view corresponding to FIG. 3 according to a second modification; and

FIG. 7 is a view corresponding to FIG. 4 according to a third modification.

### DETAILED DESCRIPTION OF THE PREFERRED EMBODIMENTS

Hereinafter, preferred embodiments of an electrical energy storage module disclosed herein will be described with reference to the drawings as appropriate. Matters that are other than matters particularly mentioned in the present specification and that are necessary for the implementation of the art disclosed herein (for example, the general configuration and manufacturing process of an electrical energy storage device that do not characterize the art disclosed herein) can be grasped as design matters of those skilled in the art based on the prior art in the relevant field. The art disclosed herein can be implemented on the basis of the disclosure of the present specification and common technical knowledge in the relevant field. Note that in the drawings below, the members and parts with the same operation are explained by being denoted by the same reference sign.

In the present specification, “electrical energy storage device” refers to a general device capable of being repeatedly charged and discharged by transfer of charge carriers between a positive electrode and a negative electrode through an electrolyte. The electrical energy storage device corresponds to a concept encompassing secondary batteries such as lithium ion secondary batteries and nickel-hydrogen batteries and capacitors such as lithium ion capacitors and electrical double-layer capacitors. In the present specification, the notation “A to B” for a range signifies a value more than or equal to A and less than or equal to B, and is meant to encompass also the meaning of being “more than A” and “less than B”.

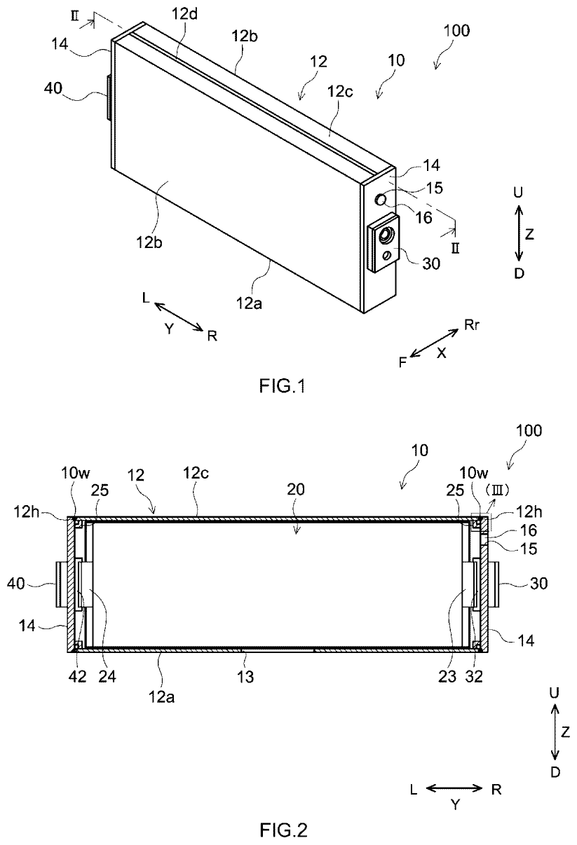

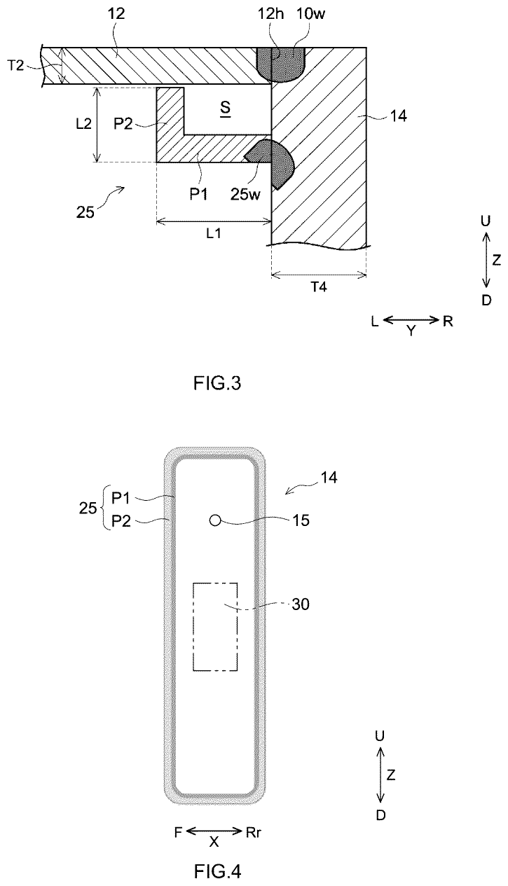

FIG. 1 is a perspective view of an electrical energy storage device 100 according to one embodiment. FIG. 2 is a schematic longitudinal cross-sectional view of the electrical energy storage device 100 taken along line II-II in FIG. 1, and illustrates an internal structure of the electrical energy storage device 100. FIG. 3 is an enlarged cross-sectional view of a main part in FIG. 2. In the following description, reference signs L, R, F, Rr, U, and D in the drawings respectively denote left, right, front, rear, up, and down, and reference signs X, Y, and Z in the drawings respectively denote a short side direction of the electrical energy storage device 100, a long side direction that is orthogonal to the short side direction, and an up-down direction that is orthogonal to the short side direction and the long side direction. However, these are merely directions for convenience of description and do not limit the mode of installation of the electrical energy storage device 100.

As illustrated in FIG. 1, the electrical energy storage device 100 has a square shape including a hexahedron (in detail, rectangular parallelepiped shape) here. As illustrated in FIG. 2, the electrical energy storage device 100 includes a battery case 10, an electrode body 20, and a shielding part 25. Here, the electrical energy storage device 100 further includes a nonaqueous electrolyte solution (not illustrated), a positive electrode terminal 30, and a negative electrode terminal 40. The electrical energy storage device 100 is a nonaqueous electrolyte secondary battery (in detail, nonaqueous electrolyte solution secondary battery) here. The electrical energy storage device 100 is preferably a lithium ion secondary battery.

As illustrated in FIG. 1, the battery case 10 has an outer shape that is a flat bottomed cuboid shape (square shape) here. As illustrated in FIG. 2, the battery case 10 includes a case main body 12 that includes an opening 12h and accommodates the electrode body 20 and the nonaqueous electrolyte solution, and a sealing plate 14 that seals the opening 12h. More specifically, the battery case 10 includes the case main body 12 including the opening 12h at each of both end parts in the long side direction Y, and two sealing plates 14 that cover the pair of openings 12h of the case main body 12 here.

The case main body 12 has a hollow rectangular cylindrical shape here. As illustrated in FIG. 1, the case main body 12 includes a lower surface 12a with a substantially rectangular shape having a pair of long sides and a pair of short sides, a pair of long side surfaces 12b facing each other and extending upward from the pair of long sides (edges) of the lower surface 12a, and an upper surface 12c facing the lower surface 12a. Here, the long side surface 12b is larger in area than the lower surface 12a and the upper surface 12c. The upper surface 12c has a substantially rectangular shape similarly to the lower surface 12a. The upper surface 12c connects upper end parts of the pair of long side surfaces 12b.

Note that in the present specification, the term “substantially rectangular shape” encompasses, in addition to a perfect rectangular shape (rectangle), for example, a rounded shape whose corner part connecting a long side and a short side of the rectangular shape is rounded, a shape whose corner part includes a notch, and the like.

The case main body 12 is formed by, for example, bending one sheet of metal plate into a tubular shape and joining(for example, joining by welding) a joint. Thus, each of the lower surface 12a, the pair of long side surfaces 12b, and the upper surface 12c has a flat plate shape and a plate thickness T2 that is substantially uniform (see FIG. 3). On the upper surface 12c of the case main body 12, a welding joining part 12d is provided. In the case main body 12, each of a border part (edge) between the long side surface 12b and the lower surface 12a and a border part (edge) between the long side surface 12b and the upper surface 12c is a bent part. Thus, even if a gas is generated in the battery case 10 and the internal pressure thereof increases, for example, the damage of the battery case 10 is suppressed. Therefore, the safety can be improved.

The plate thickness T2 (the thickness of the metal plate) of the case main body 12 is preferably 0.1 mm or more, more preferably 0.2 mm or more, and still more preferably 0.3 mm or more from the viewpoint of improving the mechanical strength, rigidity, durability, and the like, although depending on the material or the like. In addition, the plate thickness T2 of the case main body 12 is preferably 2 mm or less, more preferably 1 mm or less, still more preferably 0.7 mm or less, and particularly preferably 0.5 mm or less from the viewpoint of improving the energy density of the electrical energy storage device 100.

As illustrated in FIG. 2, the lower surface 12a of the case main body 12 includes a gas exhaust valve 13. The gas exhaust valve 13 is configured to fracture when pressure inside the battery case 10 reaches a predetermined value or more and discharge a gas in the battery case 10 to the outside. Although one gas exhaust valve 13 is provided in this embodiment, two or more gas exhaust valves 13 may be provided in another embodiment. In addition, the position, area, shape, and the like of the gas exhaust valve 13 can be changed as appropriate.

The sealing plate 14 is a plate-shaped member with a substantially rectangular shape. The area of the sealing plate 14 is smaller than that of the long side surface 12b here. The sealing plate 14 has a flat plate shape and a plate thickness T4 that is substantially uniform (see FIG. 3). The plate thickness T4 of the sealing plate 14 is preferably 0.1 mm or more, more preferably 0.2 mm or more, still more preferably 0.3 mm or more, and particularly preferably 0.5 mm or more from the viewpoint of improving the mechanical strength, rigidity, durability, and the like, although depending on the material or the like. In addition, the plate thickness T4 of the sealing plate 14 is preferably 2 mm or less, more preferably 1 mm or less, and still more preferably 0.7 mm or less from the viewpoint of improving the energy density of the electrical energy storage device 100.

In some embodiments, it is preferable that the shielding part 25 be provided at one of the case main body 12 and the sealing plate 14, and the thickness of the member to which the shielding part 25 is provided be relatively larger than the thickness of the member to which the shielding part 25 is not provided, which will be described in detail below. As illustrated in FIG. 3, in this embodiment, the shielding part 25 is provided at the sealing plate 14. In this case, the plate thickness T4 of the sealing plate 14 is preferably larger than the plate thickness T2 of the case main body 12 (T2<T4). It is preferable that the plate thickness T4 of the sealing plate 14 be preferably 1.5 times or more, more preferably twice or more, and still more preferably 2 to 3 times as large as the plate thickness T2 of the case main body 12, for example.

As illustrated in FIG. 2, one sealing plate 14 includes a liquid injection hole 15. The liquid injection hole 15 is used to inject the nonaqueous electrolyte solution into the battery case 10 after the pair of sealing plates 14 are assembled to the case main body 12. The liquid injection hole 15 is sealed with a sealing member 16 after the nonaqueous electrolyte solution is injected. A conventionally known member can be used as the sealing member 16 without particular limitations. Examples of the sealing member 16 include a blind rivet. Although the liquid injection hole 15 is provided at the sealing plate 14 in this embodiment, the liquid injection hole 15 may alternatively be provided at the case main body 12 in another embodiment.

A conventionally used material can be used for the case main body 12 and the sealing plate 14, without particular limitations. The case main body 12 and the sealing plate 14 are preferably formed of a metal such as stainless steel, aluminum, an aluminum alloy, iron, an iron alloy, or the like, and more preferably formed of stainless steel. For example, stainless steel has higher melting point and mechanical strength than aluminum and the aluminum alloy. Thus, even if a gas is generated in the battery case 10 and the internal pressure of the battery case 10 increases, for example, stainless steel is not damaged easily and the safety is excellent. In addition, in the art disclosed herein, even if such a metal with a high melting point is used, a welding joining part 10w with deep melting depth is suitably formed easily at a border part between the case main body 12 and the sealing plate 14, which will be described in detail below.

As illustrated in FIG. 2 and FIG. 3, at a peripheral edge of each of the pair of openings 12h of the case main body 12, the case main body 12 and the sealing plate 14 are butted against each other. Note that at the opening 12h of the case main body 12, a side wall extends vertically. At the peripheral edge of the opening 12h of the case main body 12, a step on which the sealing plate 14 is mounted is not provided. The welding joining part 10w is provided at a butting part between the case main body 12 and the sealing plate 14. In some embodiments, the welding joining part 10w is preferably a laser welding part formed by laser welding. The welding joining part 10w is provided in an annular shape along the peripheral edge of each of the pair of openings 12h of the case main body 12 (along an outer edge of the sealing plate 14). The battery case 10 is integrated in such a way that the sealing plates 14 are joined by welding to the peripheral edges of the pair of openings 12h of the case main body 12. Thus, the opening 12h of the case main body 12 is hermetically sealed (closed).

The shielding part 25 is a member that shields a gap between at least a part of the welding joining part 10w and the electrode body 20 inside the case main body 12. The shielding part 25 has a function of, at a part that sections a part of a space S to be described below, protecting the electrode body 20 from weld spatter that can scatter inside the case main body 12 when the welding joining part 10w is formed. In some embodiments, it is preferable that the shielding part 25 be provided at one of the case main body 12 and the sealing plate 14 and be in contact with or close to the other of the case main body 12 and the sealing plate 14. Thus, the effect of the art disclosed herein is stably exerted easily. In addition, the assemblability and the productivity of the electrical energy storage device 100 can be improved. Note that in this specification, the term “the members are in contact with or close to” can include an aspect in which such members exist with a predetermined distance (for example 0.2 mm or less, preferably 0.1 mm or less) therebetween as long as the effect of the art disclosed herein cab be obtained.

As illustrated in FIG. 3, the shielding part 25 is provided at the sealing plate 14 here. In detail, the shielding part 25 is joined (for example, joined by welding) to an inner wall surface of the sealing plate 14. At a border part between the inner wall surface of the sealing plate 14 and the shielding part 25, a joining part 25w is provided. The shielding part 25 is integrated with the sealing plate 14. The shielding part 25 is not joined to the case main body 12. The shielding part 25 is in contact with or close to (preferably, in contact with) the case main body 12. Providing the shielding part 25 at the sealing plate 14 can achieve the art disclosed herein more easily. Moreover, the case main body 12 can be thinned easily and the energy density can be improved. As will be described in a second modification below, however, the shielding part 25 may be provided at a member other than the sealing plate 14, for example, an insulating member such as the case main body 12 or a spacer.

The material of the shielding part 25 may be the same as or different from that of the case main body 12 and/or the sealing plate 14. For example, the shielding part 25 is preferably formed of a metal such as stainless steel, aluminum, an aluminum alloy, iron, or an iron alloy, and more preferably formed of stainless steel. In some embodiments, the material of the shielding part 25 preferably has a melting point that is the same as or higher than that of the case main body 12 and/or the sealing plate 14. Thus, the effect of the art disclosed herein is easily exerted at a high level.

As illustrated in FIG. 3, here, the shielding part 25 has an L-shaped cross section in a cross-sectional view along the long side surface 12b of the case main body 12 (in a cross-sectional view in a thickness direction of the case main body 12 and the sealing plate 14). The shielding part 25 includes a first part P1 extending along an inner wall surface of the case main body 12 and a second part P2 extending along the inner wall surface of the sealing plate 14. Thus, the capacity of the space S can be adjusted easily, and the large space S can be stably secured easily. As will be described in a first modification and the like below, however, the shielding part 25 may have a shape other than the L-shaped cross section, for example an I-shaped cross section, a wave-shaped cross section, or the like.

Here, the first part P1 is a part that is connected to the sealing plate 14. The joining part 25w described above is provided at the border part between the inner wall surface of the sealing plate 14 and the first part P1. Here, the first part P1 extends horizontally from the inner wall surface of the sealing plate 14 along the long side direction Y. In some embodiments, in the cross-sectional view in FIG. 3, a length L1 of the first part P1 (average length in the long side direction Y in FIG. 3, that is, protrusion length from the inner wall surface of the sealing plate 14 here) is preferably larger than the plate thickness T4 of the sealing plate 14 (T4<L1). Thus, the large space S can be stably secured easily. In addition, the effect of the art disclosed herein is easily exerted at a higher level.

Here, the second part P2 is a part that extends vertically from the first part P1 toward the case main body 12 (along the up-down direction Z), and is in contact with or close to (preferably, in contact with) the inner wall surface of the case main body 12. The second part P2 is more preferably in contact with the inner wall surface of the case main body 12. The second part P2 extends along a side surface of the electrode body 20 in the long side direction Y. In some embodiments, in the cross-sectional view in FIG. 3, a length L2 of the second part P2 (average length in the up-down direction Z in FIG. 3, that is, extension length from the first part P1 here) is preferably larger than the plate thickness T2 of the case main body 12 (T2<L2). Thus, the large space S can be stably secured easily. In addition, the effect of the art disclosed herein is more stably exerted easily. The length L2 of the second part P2 is smaller than the length L1 of the first part P1 here (L2<L1). Therefore, the interference between the shielding part 25 and the case main body 12 can be suppressed and the assemblability and the workability can be improved.

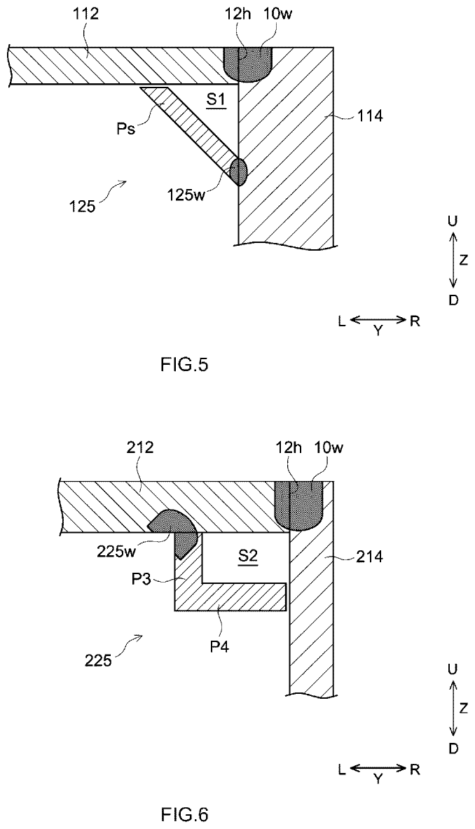

FIG. 4 is a schematic plan view of the sealing plate 14. FIG. 4 illustrates the inner wall surface of the sealing plate 14 (surface on a side facing the electrode body 20). As illustrated in FIG. 4, in this embodiment, the shielding part 25 is provided in an annular shape along the outer edge of the sealing plate 14. Thus, in the electrical energy storage device 100, the shielding part 25 is provided in an annular shape (continuously) along the welding joining part 10w. The shielding part 25 shields the gap between the welding joining part 10w with an annular shape and the electrode body 20 along the entire circumference. As will be described in a third modification and the like below, however, it is not always necessary that the shielding part 25 is provided in an annular shape (continuously) along the outer edge of the sealing plate 14.

As illustrated in FIG. 3, in at least a part of a peripheral edge of the welding joining part 10w, the space S that is surrounded by the shielding part 25, the case main body 12, and the sealing plate 14 is secured. In the cross-sectional view in FIG. 3, the space S is surrounded by the first part P1 and the second part P2 of the shielding part 25, the inner wall surface of the case main body 12, and the inner wall surface of the sealing plate 14, and has a substantially quadrangular shape (in detail, a substantially rectangular shape). As indicated in FIG. 3 and FIG. 4, the space S is provided in an annular shape along the outer edge of the sealing plate 14 (along the welding joining part 10w with the annular shape) here.

In this manner, the space S is secured inside the battery case 10 (in detail, inside the case main body 12). Thus, even if the weld spatter scatters inside the case main body 12 when the welding joining part 10w is formed, the weld spatter can be received by the space S and kept away from the electrode body 20. Therefore, the damage of the electrode body 20 due to the weld spatter is suppressed. Moreover, even if the battery case 10 (the case main body 12 and/or the sealing plate 14) is thinned more than before from the viewpoints of improving the energy density of the electrical energy storage device 100 and the like, the welding joining part 10w with deep welding depth (melting-in) can be formed without considering the weld spatter. Thus, even if the battery case 10 is thinned more than before, the sealability of the welding joining part 10w can be secured stably.

In addition, according to the present inventor's knowledge, “heat accumulation” can be generated in the space S when the welding joining part 10w is formed. Thus, even the metal with the high melting point (for example, stainless steel) can be melted easily and the welding joining part 10w with deep welding depth can be stably formed easily. Therefore, even if the metal with the high melting point (for example, stainless steel) is used for the battery case 10 (the case main body 12 and/or the sealing plate 14), the sealability of the welding joining part 10w can be increased more.

In some embodiments, the capacity of the space S is preferably larger than the volume of the welding joining part 10w that is provided at the butting part between the case main body 12 and the sealing plate 14. In some embodiment, the depth of the space S (average length in the up-down direction Z in FIG. 3) is preferably larger than the plate thickness T2 of the case main body 12. Thus, if the metal melted in the welding joining should melt and fall inside the case main body 12, the space S can receive the molten and fallen metal suitably. Therefore, the effect of the art disclosed herein is easily exerted at the higher level. Note that the magnitude relation between the capacity of the space S and the volume of the welding joining part 10w can be grasped by comparing both areas in an image in the cross-sectional view in the thickness direction of the sealing plate 14 in FIG. 3, for example.

The electrode body 20 is accommodated inside the battery case 10 as illustrated in FIG. 2. Although not illustrated, the electrode body 20 includes a positive electrode and a negative electrode. The structure of the electrode body 20 may be similar to the conventional one without particular limitations. The positive electrode typically includes a positive electrode current collector and a positive electrode active material layer fixed to the positive electrode current collector. The negative electrode typically includes a negative electrode current collector and a negative electrode active material layer fixed to the negative electrode current collector. The electrode body 20 may be accommodated inside the battery case 10 while being covered with an insulating sheet (electrode body holder) made of resin. The electrode body 20 may be accommodated inside the battery case 10 while being integrated with an insulating member (for example, a spacer) made of resin, for example.

The number of electrode bodies 20 to be accommodated inside the battery case 10 is not limited in particular and may be one, or two or more. The electrode body 20 is here a wound electrode body in which the positive electrode with a band shape and the negative electrode with a band shape are stacked through a separator with a band shape and wound in a longitudinal direction using a winding axis as a center. In this embodiment, the electrode body 20 is disposed inside the battery case 10 with the winding axis substantially parallel to the long side direction Y. In another embodiment, however, the electrode body 20 may be a multilayer electrode body in which a plurality of square positive electrodes and a plurality of square negative electrodes are stacked in the short side direction X through the separator, for example, in an insulated state. In addition, the respective members (positive electrode, negative electrode, separator, and the like) included in the electrode body 20 may be similar to those of the general electrical energy storage device without particular limitations.

As illustrated in FIG. 2, a positive electrode tab 23 is provided in the positive electrode of the electrode body 20. The positive electrode tab 23 is a part of the positive electrode current collector here. The positive electrode tab 23 has a convex shape here, and protrudes from the electrode body 20 toward the first sealing plate 14 (the right side in the long side direction Y in FIG. 2). The positive electrode tab 23 is electrically connected to the positive electrode terminal 30 through a positive electrode current collecting part 32 here. On the other hand, a negative electrode tab 24 is provided in the negative electrode of the electrode body 20. The negative electrode tab 24 is a part of the negative electrode current collector here. The negative electrode tab 24 has a convex shape here, and protrudes from the electrode body 20 toward the second sealing plate 14 (the left side in the long side direction Y in FIG. 2). The negative electrode tab 24 is electrically connected to the negative electrode terminal 40 through a negative electrode current collecting part 42 here.

The nonaqueous electrolyte solution is accommodated inside the battery case 10 together with the electrode body 20. The nonaqueous electrolyte solution may be similar to the conventional one without particular limitations. The nonaqueous electrolyte solution is a nonaqueous liquid electrolyte including a nonaqueous solvent and a supporting salt. Examples of the nonaqueous solvent include carbonates such as ethylene carbonate (EC), ethyl methyl carbonate (EMC), and dimethyl carbonate (DMC). Examples of the supporting salt (electrolyte salt) include fluorine-containing lithium salt such as LiPF₆ and fluorine-containing sodium salt such as NaPF₆. In another embodiment, however, a solid-state electrolyte (solid electrolyte) that is integrated with the electrode body 20 may be included instead of the nonaqueous electrolyte solution.

Here, the positive electrode terminal 30 and the negative electrode terminal 40 are fixed to surfaces of the battery case 10 that face each other (specifically, the pair of sealing plates 14). In detail, the positive electrode terminal 30 is attached to the first sealing plate 14 (the right sealing plate 14 in the long side direction Y in FIG. 1 and FIG. 2). The positive electrode terminal 30 is preferably made of metal, and is more preferably formed of aluminum or an aluminum alloy, for example. As illustrated in FIG. 2, the positive electrode terminal 30 is electrically connected to the positive electrode tab 23 through the positive electrode current collecting part 32 inside the battery case 10.

The negative electrode terminal 40 is attached to the second sealing plate 14 (the left sealing plate 14 in the long side direction Y in FIG. 1 and FIG. 2). The negative electrode terminal 40 is preferably made of metal and is more preferably formed of copper or a copper alloy, for example. As illustrated in FIG. 2, the negative electrode terminal 40 is electrically connected to the negative electrode tab 24 through the negative electrode current collecting part 42 inside the battery case 10. Note that in this embodiment, the positive electrode terminal 30 and the negative electrode terminal 40 are provided at the pair of sealing plates 14; however, in another embodiment, the positive electrode terminal 30 and the negative electrode terminal 40 may be provided at the same sealing plate 14 or may be provided at the case main body 12.

The aforementioned electrical energy storage device 100 can be manufactured by, for example, a manufacturing method including the following steps typically in this order: a battery case preparing step, an electrode body accommodating step, a welding joining step, and a liquid injecting step. In the battery case preparing step, the case main body 12 and the two sealing plates 14 are prepared. The case main body 12 can be prepared by, for example, bending one sheet of metal plate into a tubular shape and joining (for example, joining by welding) a joint. The sealing plate 14 can be prepared by joining (for example, joining by welding) the shielding part 25 to a rectangular metal plate with the size corresponding to the opening 12h of the case main body 12, for example. Thus, a sealing plate assembly in which the shielding part 25 is integrated with the sealing plate 14 is obtained. Moreover, the positive electrode terminal 30 is attached to the first sealing plate 14, and the negative electrode terminal 40 is attached to the second sealing plate 14.

In the electrode body accommodating step, the electrode body 20 that is prepared separately is accommodated in the case main body 12. In one example, after the electrode body 20 is accommodated in the case main body 12, the positive electrode tab 23 of the electrode body 20 is joined to the positive electrode current collecting part 32 and electrically connected to the positive electrode terminal 30 provided at the first sealing plate 14. In addition, the negative electrode tab 24 of the electrode body 20 is joined to the negative electrode current collecting part 42 and electrically connected to the negative electrode terminal 40 provided at the second sealing plate 14.

In the welding joining step, the opening 12h of the case main body 12 is sealed with the sealing plate 14 (sealing plate assembly). In one example, if the sealing plate 14 is butted against the opening 12h of the case main body 12, the space S that is surrounded by the shielding part 25, the case main body 12, and the sealing plate 14 is secured at the peripheral edge of the opening 12h inside the case main body 12. In this state, the butting part between the case main body 12 and the sealing plate 14 is joined by welding. A method of the welding is not limited in particular and may be, for example, laser welding, electron beam welding, ultrasonic welding, resistance welding, or the like. In particular, the laser welding is preferable. In this manner, the welding joining part 10w is formed and the opening 12h of the case main body 12 is sealed.

As described above, the space S is secured at the peripheral edge of the opening 12h. Thus, even if the weld spatter scatters inside the case main body 12 when the welding joining part 10w is formed, the weld spatter can be received by the space S and kept away from the electrode body 20. Thus, according to the art disclosed herein, the damage of the electrode body 20 is suppressed in this step. In addition, since the welding joining part 10w with deep welding depth (melting-in) can be formed without considering the weld spatter, the sealability of the welding joining part 10w can be secured stably. Moreover, when the welding joining part 10w is formed, “the heat accumulation” can be generated in the space S. Thus, even the metal with the high melting point (for example, stainless steel) is melted easily and the welding joining part 10w with deep welding depth can be stably formed easily. Therefore, even the metal with the high melting point (for example, stainless steel) can be used suitably.

In the liquid injecting step, the nonaqueous electrolyte solution is injected into the battery case 10. In this embodiment, the nonaqueous electrolyte solution is injected into the battery case 10 from the liquid injection hole 15. The liquid injection hole 15 is sealed with the sealing member 16 after the nonaqueous electrolyte solution is injected. In this manner, the electrical energy storage device 100 can be manufactured.

The electrical energy storage device 100 can be used in various applications, and for example, suitably used as a motive power source (electrical power source for driving) for a motor mounted on a vehicle such as a passenger car or a truck. Although the type of vehicles is not particularly limited, examples thereof may include a plug-in hybrid electric vehicle (PHEV), a hybrid electric vehicle (HEV), a battery electric vehicle (BEV), and the like.

The embodiments of the art disclosed herein has been described above; however, these are just examples and will not limit the scope of claims. The art described in the scope of claims includes those in which the specific examples given above are variously modified and changed. Note that in the description of the following modifications, the description of the matters that are common to those of the embodiment is omitted or simplified.

### First Modification

In the aforementioned embodiment, the shielding part 25 has the L-shaped cross section and includes the first part P1 and the second part P2. However, the present disclosure is not limited to this example. FIG. 5 is a view corresponding to FIG. 3 according to a first modification. A shielding part 125 illustrated in FIG. 5 has an I-shaped cross section and includes a straight part Ps that extends from an inner wall surface of a sealing plate 114 toward an inner wall surface of a case main body 112. The straight part Ps has a thickness that is substantially uniform here. The straight part Ps is connected to the sealing plate 114 here. At a border part between the inner wall surface of the sealing plate 114 and the straight part Ps, a joining part 125w is provided. In this modification, in a cross-sectional view in FIG. 5, a space S1 is a space with a substantially triangular shape that is surrounded by the straight part Ps of the shielding part 125, the inner wall surface of the case main body 112, and the inner wall surface of the sealing plate 114. Even in an electrical energy storage device including the shielding part 125 and the space S1 described above, the effect of the art disclosed herein can be exerted suitably.

### Second Modification

In the embodiment and the first modification described above, the shielding parts 25 and 125 are provided at the sealing plates 14 and 114, and at the border parts between the sealing plates 14 and 114 and the shielding parts 25 and 125, the joining parts 25w and 125w are provided, respectively. However, the member to which the shielding part is provided is not limited to the sealing plate. The shielding part may be provided at the case main body or a third member (for example, a spacer, an insulating member made of resin that is disposed inside the case main body 12, or the like).

FIG. 6 is a view corresponding to FIG. 3 according to a second modification. A shielding part 225 illustrated in FIG. 6 is provided at a case main body 212. The shielding part 225 includes a first part P3 that is connected to the case main body 212 and extends along an inner wall surface of a sealing plate 214, and a second part P4 that extends from one end part of the first part P3 along an inner wall surface of the case main body 212 and is in contact with or close to (preferably, in contact with) the inner wall surface of the sealing plate 214. At a border part between the inner wall surface of the case main body 212 and the first part P3, a joining part 225w is provided. The shielding part 225 is not joined to the sealing plate 214. In this modification, on the contrary to the aforementioned embodiment, the plate thickness T2 of the case main body 212 to which the shielding part 225 is provided is preferably larger than the plate thickness T4 of the sealing plate 214 (T2>T4).

In this modification, in a cross-sectional view in FIG. 6, a space S2 is a space with a substantially quadrangular shape (in detail, a substantially rectangular shape) that is surrounded by the first part P3 and the second part P4 of the shielding part 225, the inner wall surface of the case main body 212, and the inner wall surface of the sealing plate 214. Even in an electrical energy storage device including the shielding part 225 and the space S2 described above, the effect of the art disclosed herein can be exerted suitably.

### Third Modification

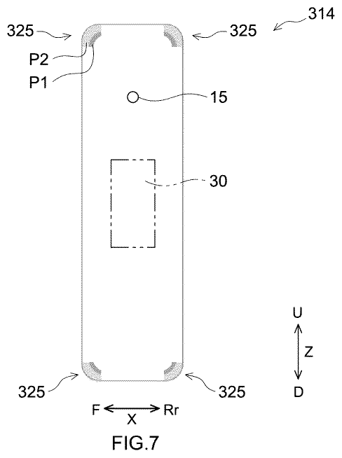

FIG. 7 is a view corresponding to FIG. 4 according to a third modification. A sealing plate 314 illustrated in FIG. 7 includes four shielding parts 325. The shielding part 325 is provided at each of corner parts of the sealing plate 314 with a substantially rectangular shape. In detail, in this modification, the corner part of the sealing plate 314 has a rounded shape and at four rounded corner parts, the shielding parts 325 with a substantially C-like shape in a plan view are provided. At a straight part of the sealing plate 314 (a part along the short side direction X or the up-down direction Z), the shielding part 325 is not provided. Thus, in an electrical energy storage device in this modification, at four corner parts (four corners) of a welding joining part with a substantially rectangular shape in a plan view, the shielding parts 325 are provided.

According to the present inventor's examination, in the welding joining, the long side surfaces 12b of the case main body 12 may be pressed and fixed by a pair of clamps with a block shape (jigs) and in this state, the sealing plate 14 may be welded to the peripheral edge of the opening 12h of the case main body 12. In this case, at the corner part of the substantially rectangular shape, a relatively large gap is generated easily. On the contrary, since the straight part of the sealing plate 314 is held between the jigs, the large gap is not generated easily. Therefore, by providing the shielding part 325 in at least the corner part of the substantially rectangular shape, the effect of the art disclosed herein can be exerted suitably.

### Fourth Modification

In the aforementioned embodiment, the case main body 12 has the rectangular cylindrical shape, and includes the openings 12h at both end parts in the long side direction Y. In addition, the number of sealing plates 14 is two. However, the present disclosure is not limited to this example. In the battery case in the modification, the case main body 12 may have a bottomed square shape (box shape) having an opening at only one end part. In this case, the number of sealing plates may be one.

As described above, the following items are given as specific aspects of the art disclosed herein.

Item 1: The electrical energy storage device including: the electrode body; the case main body that includes the opening and accommodates the electrode body; the sealing plate that seals the opening; the welding joining part that is provided at the butting part between the case main body and the sealing plate; and the shielding part that shields the gap between at least a part of the welding joining part and the electrode body inside the case main body, in which in at least a part of the peripheral edge of the welding joining part, the space that is surrounded by the shielding part, the case main body, and the sealing plate is secured.

Item 2: The electrical energy storage device according to Item 1, in which the shielding part is provided at one of the case main body and the sealing plate and is in contact with or close to the other of the case main body and the sealing plate.

Item 3: The electrical energy storage device according to Item 1 or 2, in which the shielding part is provided at the sealing plate.

Item 4: The electrical energy storage device according to Item 3, in which the plate thickness of the sealing plate is larger than the plate thickness of the case main body.

Item 5: The electrical energy storage device according to any one of Items 1 to 4, in which the shielding part is provided in the annular shape along the welding joining part.

Item 6: The electrical energy storage device according to any one of Items 1 to 4, in which the welding joining part has the substantially rectangular shape in the plan view and the shielding part is provided at each of at least four corner parts of the substantially rectangular shape.

Item 7: The electrical energy storage device according to any one of Items 1 to 6, in which the capacity of the space is larger than the volume of the welding joining part that is provided at the butting part.

Item 8: The electrical energy storage device according to any one of Items 1 to 7, in which the shielding part has the L-shaped cross section, and includes the first part extending along the inner wall surface of the case main body and the second part extending along the inner wall surface of the sealing plate.

Item 9: The electrical energy storage device according to Item 8, in which the length of the first part extending along the case main body is larger than the plate thickness of the sealing plate.

Item 10: The electrical energy storage device according to Item 8 or 9, in which the length of the second part extending along the sealing plate is larger than the plate thickness of the case main body.

Item 11: The electrical energy storage device according to any one of Items 1 to 10, in which the case main body and the sealing plate are formed of stainless steel.

### REFERENCE SIGNS LIST

10 Battery case
10w Welding joining part
12, 112, 212 Case main body
14, 114, 214, 314 Sealing plate
20 Electrode body
25, 125, 225, 325 Shielding part
100 Electrical energy storage device
S, S1, S2 Space

What is claimed is

1. An electrical energy storage device comprising:
an electrode body;
a case main body that includes an opening and accommodates the electrode body;
a sealing plate that seals the opening;
a welding joining part that is provided at a butting part between the case main body and the sealing plate; and
a shielding part that shields a gap between at least a part of the welding joining part and the electrode body inside the case main body,
wherein in at least a part of a peripheral edge of the welding joining part, a space that is surrounded by the shielding part, the case main body, and the sealing plate is secured.

2. The electrical energy storage device according to claim 1, wherein the shielding part is provided at one of the case main body and the sealing plate and is in contact with or close to the other of the case main body and the sealing plate.

3. The electrical energy storage device according to claim 1, wherein the shielding part is provided at the sealing plate.

4. The electrical energy storage device according to claim 3, wherein a plate thickness of the sealing plate is larger than a plate thickness of the case main body.

5. The electrical energy storage device according to claim 1, wherein the shielding part is provided in an annular shape along the welding joining part.

6. The electrical energy storage device according to claim 1, wherein the welding joining part has a substantially rectangular shape in a plan view and the shielding part is provided at each of at least four corner parts of the substantially rectangular shape.

7. The electrical energy storage device according to claim 1, wherein a capacity of the space is larger than a volume of the welding joining part that is provided at the butting part.

8. The electrical energy storage device according to claim 1, wherein the shielding part has an L-shaped cross section, and includes a first part extending along an inner wall surface of the case main body and a second part extending along an inner wall surface of the sealing plate.

9. The electrical energy storage device according to claim 8, wherein a length of the first part extending along the case main body is larger than the plate thickness of the sealing plate.

10. The electrical energy storage device according to claim 8, wherein a length of the second part extending along the sealing plate is larger than the plate thickness of the case main body.

11. The electrical energy storage device according to claim 1, wherein the case main body and the sealing plate are formed of stainless steel.
